(19) United States
(12) Patent Application Publication
(10) Pub. No.: US 2025/0187912 A1
(43) Pub. Date: Jun. 12, 2025

(54) CATALYST AND METHOD OF DECOMPOSING GASEOUS AMMONIA

(71) Applicant: INDUSTRIAL TECHNOLOGY RESEARCH INSTITUTE, Hsinchu (TW)

(72) Inventors: Cheng-Po KUO, New Taipei City (TW); Shin-Liang KUO, Hsinchu City (TW); Jian-Yi HANG, Zhonghe City (TW); Kuo-Ching WU, Kinmen County (TW); Hsi-Yen HSU, Hsinchu City (TW)

(73) Assignee: INDUSTRIAL TECHNOLOGY RESEARCH INSTITUTE, Hsinchu (TW)

(21) Appl. No.: 18/954,746

(22) Filed: Nov. 21, 2024

Related U.S. Application Data
(60) Provisional application No. 63/607,823, filed on Dec. 8, 2023.

(30) Foreign Application Priority Data
Sep. 26, 2024 (TW) 113136689

(51) Int. Cl. C01B 3/04; B01J 23/02; B01J 23/58; B01J 37/02; B01J 37/18

(52) U.S. Cl. CPC C01B 3/047; B01J 23/02; B01J 23/58; B01J 37/024; B01J 37/18

(57) ABSTRACT

A catalyst includes a ruthenium metal loaded on a support, wherein the support has a chemical formula of AₓB₍₁₋ₓ₎O_{y}. A is an alkaline earth metal, B is aluminum, zinc, cerium, manganese, or a combination thereof, x is 0.05 to 0.50, and y is chemical stoichiometry. The catalyst may further include an auxiliary agent loaded on the support. The catalyst can be used to decompose gaseous ammonia.

### CROSS REFERENCE TO RELATED APPLICATIONS

This application claims the benefit of U.S. Provisional Application No. 63/607,823, filed one Dec. 8, 2023, the entirety of which is incorporated by reference herein.

The present application is based on, and claims priority from, Taiwan Application Serial Number 113136689, filed on Sep. 26, 2024, the disclosure of which is hereby incorporated by reference herein in its entirety.

### TECHNICAL FIELD

The technical field relates to a catalyst for decomposing ammonia.

### BACKGROUND

According to the 2050 net-zero emissions plan announced by the International Energy Agency (IEA), hydrogen energy technology is critical to achieve net-zero emissions by 2050, and it will be used to compensate for the gaps between the renewable energy and the electrification industries. In addition to this, carbon dioxide conversion process also needs a large amount of hydrogen.

Hydrogen storage and transportation are mainly realized in a high-pressure gaseous state (70 MPa) or a low-temperature liquid state (−253° C.) through vehicle transportation. However, such kind of transportation has issues such as low-volume energy density, large safety hazards, high costs, large infrastructure investment, and so forth. If hydrogen is transported by pipeline, new pipeline infrastructure maybe needed due to hydrogen embrittlement problem, which is costly and risky. Therefore, the industry has proposed various alternatives, such as to use organic liquids (methylcyclohexane) and liquid ammonia as hydrogen storage carriers. Ammonia has the highest potential in development and application owing to its highest hydrogen storage volume density, mild storage condition requirement, and low carbon emissions.

If ammonia is selected as a hydrogen storage carrier, it will require ammonia decomposition technology to produce hydrogen, in which hydrogen production catalyst is considered as a key technology. However, the reaction rate of the existing catalyst technology is obviously insufficient. The activities of these catalysts are relatively low at lower reaction temperatures (400° C. to 500° C.) and high reaction gas hourly space velocity, resulting in relatively low conversion rates. In addition, the existing catalysts have poor stability. Accordingly, a novel catalyst for addressing the above issue is called for.

### SUMMARY

One embodiment of the disclosure provides a catalyst including ruthenium metal loaded on a support, wherein the support has a chemical formula of AₓB₍₁₋ₓ₎O_{y}. A is an alkaline earth metal, B is aluminum, zinc, cerium, manganese, or a combination thereof, x is 0.05 to 0.50, and y is chemical stoichiometry.

One embodiment of the disclosure provides a method of decomposing gaseous ammonia, including: contacting the described catalyst with gaseous ammonia to form nitrogen and hydrogen, wherein the catalyst contacts gaseous ammonia at a temperature of 300° C. to 700° C. under a pressure of 1 atm to 1.2 atm.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a catalyst including ruthenium metal loaded on a support, wherein the support has a chemical formula of AₓB₍₁₋ₓ₎O_{y}. A is alkaline earth metal, B is aluminum, zinc, cerium, manganese, or a combination thereof, x is 0.05 to 0.50, and y is chemical stoichiometry. In some embodiments, the alkaline earth metal is magnesium, calcium, or a combination thereof. If x is too high or too low, the gaseous ammonia decomposing effect of the catalyst will be insufficient. Here, y is chemical stoichiometry, which corresponds to the amounts and the oxidation numbers of A and B. For example, if A is magnesium and B is aluminum, it can be calculated that 2y=2x+3−3x, i.e. y=(3−x)/2. If A is magnesium and B is zinc, it can be calculated that 2y=2x+2−2x, i.e. y=1. If A is magnesium and B is cerium, it can be calculated that 2y=2x+4−4x, i.e. y=2−x.

In some embodiments, the ruthenium metal and the catalyst have a weight ratio of 0.5:100 to 7:100. If the amount of ruthenium metal is too low, the gaseous ammonia cannot be efficiently decomposed. If the amount of ruthenium metal is too high, not only the capability of decomposing gaseous ammonia cannot be further improved, the cost of the catalyst will also be increased.

In some embodiments, the catalyst further includes an auxiliary agent loaded on the support, and the auxiliary agent is Li₃N, LI₂NH, or LiNH₂. In some embodiments, the auxiliary agent and the catalyst have a weight ratio of 0.1:100 to 20:100. If the amount of auxiliary agent is too high, the capability of decomposing gaseous ammonia will be lowered.

In some embodiments, the catalyst can be prepared by following method. First, the support is prepared, and ruthenium is then loaded on the support. In some embodiments, the auxiliary agent can be optionally further loaded on the support. A first solution can be prepared during preparing the support. The first solution contains salt of A, reagent of B, alkaline, and solvent. For example, the salt of A, the reagent of B, and alkaline can be dissolved in the solvent, and then mixed and stirred to form the first solution. Each of the salt of A and the reagent of B can independently be metal nitrate salt, metal sulfate salt, metal carbonate salt, or metal chloride. In some embodiments, the salt of A can be magnesium nitrate, magnesium sulfate, magnesium carbonate, magnesium chloride, calcium nitrate, calcium sulfate, calcium carbonate, calcium chloride, or a combination thereof. The reagent of B can be aluminum nitrate, aluminum sulfate, aluminum carbonate, aluminum oxide, aluminum hydroxide, aluminum chloride, zinc nitrate, zinc sulfate, zinc carbonate, zinc oxide, zinc hydroxide, zinc chloride, cerium nitrate, cerium sulfate, cerium carbonate, cerium oxide, cerium hydroxide, cerium chloride, manganese nitrate, manganese sulfate, manganese carbonate, manganese oxide, manganese hydroxide, manganese chloride, or a combination thereof. In some embodiments, the salt of A and the reagent of B may have a molar ratio of 0.5:1 to 1:1. The solvent can be de-ionized water, mono alcohol, or a combination thereof. In some embodiments, the alkaline can be sodium hydroxide, sodium carbonate, or a combination thereof, and the pH value of the first solution can be 8 to 12. The mixing and stirring can be performed at a temperature of 25° C. (room temperature) to 100° C. for a period of 4 hours to 18 hours.

Next, a second solution was prepared. The second solution contains the described first solution and an oxide of metal B (e.g. aluminum oxide, zinc oxide, cerium oxide, manganese oxide, or a combination thereof). More specifically, the oxide of metal B was added to the first solution, and then continuously stirred to form the second solution. In some embodiments, B from the oxide of metal B and A from the salt of A may have a molar ratio of 1:1 to 5:1. The mixing and stirring can be performed at a temperature of 25° C. (room temperature) to 60° C. for a period of 1 hour to 18 hours.

Subsequently, the second solution was filtered to obtain a filtered cake. The filtered cake is then washed by water, baked dry, and sintered to form a support AₓB₍₁₋ₓ₎O_{y}. In some embodiments, the baking dry is performed at a temperature of 100° C. to 130° C. for a period of 4 hours to 18 hours. The sintering is performed at a temperature of 400° C. to 500° C. for a period of 3 hours to 6 hours.

In some embodiments, a solution of the salt of A and the oxide of metal B can be optionally directly mixed.

Subsequently, the ruthenium metal is loaded on the support. More specifically, the ruthenium-containing precursor is loaded on the surface of the support to form a catalyst precursor. The ruthenium-containing precursor can be ruthenium chloride (RuCl₃), ruthenium (III) nitrosyl nitrate, ruthenium oxynitrate, or ruthenium (III) acetylacetonate. In some embodiments, the method of loading ruthenium-containing precursor on the surface of the support can be incipient wetness impregnation or sedimentation precipitation method. In one embodiment, the incipient wetness impregnation includes adding ruthenium chloride to an appropriate amount of de-ionized water to prepare an impregnated solution. The incipient wetness impregnation can be performed at a temperature of 25° C. (room temperature) to 60° C. for a period of 1 hour to 4 hours. The ruthenium concentration of the impregnated solution can be 0.5 wt % to 5 wt %. The support is impregnated in the impregnated solution, and then filtered to collect a filtered cake. The filtered cake is baked dry to obtain a support with the ruthenium-containing precursor loaded thereon. In some embodiments, the baking dry is performed at a temperature of 100° C. to 130° C. for a period of 4 hours to 18 hours. The support with the ruthenium-containing precursor loaded thereon is then sintered to obtain the catalyst (e.g. ruthenium metal loaded on the support). The sintering can be performed at a temperature of 300° C. to 550° C. for a period of 4 hours to 18 hours.

In another embodiment, the support with the ruthenium-containing precursor loaded thereon was added to THE solvent to be continuously stirred. Subsequently, an auxiliary agent is added to the THF solvent to be mixed with the support. Next, the mixture is filtered to obtain a filtered cake, which is baked dry and sintered to obtain the catalyst (e.g. the ruthenium metal and the auxiliary agent loaded on the support). The baking dry is performed at a temperature of 50° C. to 80° C. for a period of 1 hour to 2 hours. The sintering can be performed at a temperature of 300° C. to 550° C. for a period of 4 hours to 18 hours.

It should be understood that the method of forming the catalyst is only for illustration rather than limiting the disclosure thereto. One skilled in the art may adopt any suitable method to form the catalyst, and is not limited to the described method.

One embodiment of the disclosure provides a method of decomposing gaseous ammonia, including: contacting the described catalyst with gaseous ammonia to form nitrogen and hydrogen. The catalyst contacts gaseous ammonia at a temperature of 300° C. to 700° C. under a pressure of 1 atm to 1.2 atm. If the catalyst contacts gaseous ammonia at a temperature that is too high, the active metal will sinter easily to lower the effect of decomposing gaseous ammonia. If the catalyst contacts gaseous ammonia at a temperature that is too low, the effect of decomposing gaseous ammonia will be too low. In one embodiment, the gaseous ammonia is decomposed under a normal pressure, so that high-pressure equipment is not required and costs can be saved.

In some embodiments, the gaseous ammonia has a gas hourly space velocity of 1,000 h⁻¹ to 60,000 h⁻¹. If the gas hourly space velocity is too low, the hydrogen production efficiency will be too low. If the gas hourly space velocity is too high, the effect of decomposing gaseous ammonia will be too low.

Below, exemplary embodiments will be described in detail with reference to accompanying drawings so as to be easily realized by a person having ordinary knowledge in the art. The inventive concept may be embodied in various forms without being limited to the exemplary embodiments set forth herein.

### EXAMPLES

In following Examples, gaseous ammonia decomposition was performed in a fixed bed reaction device that utilized a quartz tube reactor. A thermocouple was disposed on an outer sidewall of the quartz reactor. Gas compositions of reactants and products were analyzed online by the laser gas analyzer CI-PC68-1.

During gaseous ammonia decomposition, the conversion rate (%) was calculated as below:

Conversion rate (%)=(Fᵢₙ,NH₃−Fₒᵤₜ,NH₃)/Fin,NH₃×100%

Fᵢₙ,NH₃ was the inlet gas hourly space velocity of gaseous ammonia, and Fₒᵤₜ,NH₃ was the outlet gas hourly space velocity of gaseous ammonia.

### Example 1

Magnesium nitrate (256 g) and aluminum nitrate (357 g) were dissolved in de-ionized water to form an aqueous solution (1 L). Sodium hydroxide (20 wt %) was dissolved in de-ionized water to form an aqueous solution (1 L). The aqueous solution of magnesium nitrate and aluminum nitrate was added to the aqueous solution of sodium hydroxide, and then stirred at room temperature for 18 hours. Subsequently, 360 g of aluminum oxide powder was added to the solution and continuously and evenly stirred, and then filtered to collect a filtered cake. The filtered cake was washed by water and then baked dry, and then sintered at 450° C. for 4 hours to obtain a support S1 (MgₓAl₍₁₋ₓ₎O_{(3-x)/2}, x=0.15).

The support S1 (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of LiNH₂ (1.0 g) to be stirred and mixed, and then filtered to collect a filtered cake. The filtered cake was baked dry, and then chemically reduced by hydrogen at 500° C. for 2 hours to obtain a catalyst C1 (loaded with ruthenium and LiNH₂). In the catalyst C1, ruthenium and the catalyst C1 had a weight ratio of 3:100, and the auxiliary agent LiNH₂ and the catalyst C1 had a weight ratio of 11:100.

1.25 g of the catalyst C1 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 96%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 90%.

### Example 2

Magnesium nitrate (256 g) and aluminum nitrate (357 g) were dissolved in de-ionized water to form an aqueous solution (1 L). Sodium hydroxide (20 wt %) was dissolved in de-ionized water to form an aqueous solution (1 L). The aqueous solution of hydroxide, and then stirred at room temperature for 18 hours. Subsequently, 160 g of aluminum oxide powder was added to the solution and continuously and evenly stirred, and then filtered to collect a filtered cake. The filtered cake was washed by water and then baked dry, and then sintered at 450° C. for 4 hours to obtain a support S2 (MgₓAl₍₁₋ₓ₎O_{(3-x)/2}, x=0.25).

The support S2 (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C2 (loaded with ruthenium). In the catalyst C2, ruthenium and the catalyst C2 had a weight ratio of 3:100.

1.25 g of the catalyst C2 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 91%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 80%.

### Example 3

Magnesium nitrate (80 g) and aluminum nitrate (357 g) were dissolved in de-ionized water to form an aqueous solution (1 L). Sodium hydroxide (20 wt %) was dissolved in de-ionized water to form an aqueous solution (0.7 L). The aqueous solution of hydroxide, and then stirred at room temperature for 18 hours. Subsequently, 350 g of aluminum oxide powder was added to the solution and continuously and evenly stirred, and then filtered to collect a filtered cake. The filtered cake was washed by water and then baked dry, and then sintered at 450° C. for 4 hours to obtain a support S3 (MgₓAl₍₁₋ₓ₎O_{(3-x)/2}, x=0.05).

The support S3 (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C3 (loaded with ruthenium). In the catalyst C3, ruthenium and the catalyst C3 had a weight ratio of 3:100.

1.25 g of the catalyst C3 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 84%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 77%.

### Example 4

Magnesium nitrate (256 g) and aluminum nitrate (80 g) were dissolved in de-ionized water to form an aqueous solution (1 L). Sodium hydroxide (20 wt %) was dissolved in de-ionized water to form an aqueous solution (0.55 L). The aqueous solution of hydroxide, and then stirred at room temperature for 18 hours. Subsequently, 60 g of aluminum oxide powder was added to the solution and continuously and evenly stirred, and then filtered to collect a filtered cake. The filtered cake was washed by water and then baked dry, and then sintered at 450° C. for 4 hours to obtain a support S4 (MgₓAl₍₁₋ₓ₎O_{(3-x)/2}, x=0.5).

The support S4 (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C4 (loaded with ruthenium). In the catalyst C4, ruthenium and the catalyst C4 had a weight ratio of 3:100.

1.25 g of the catalyst C4 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 85%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 77%.

### Example 5

The support S1 (8 g) in Example 1 was weighed and added to an aqueous solution of RuCl₃ (0.82 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed, and then added to a THF solution of LiNH₂ (2.0 g) to be stirred and mixed, and then filtered to collect a filtered cake. The filtered cake was baked dry, and then chemically reduced by hydrogen at 500° C. for 2 hours to obtain a catalyst C5 (loaded with ruthenium and LiNH₂). In the catalyst C5, ruthenium and the catalyst C5 had a weight ratio of 3:100, and the auxiliary agent LiNH₂ and the catalyst C5 had a weight ratio of 20:100.

1.25 g of the catalyst C5 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 86%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 78%.

### Example 6

The support S1 (8 g) in Example 1 was weighed and added to an aqueous solution of RuCl₃ (0.75 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of Li₂NH (1.0 g) to be stirred and mixed, and then filtered to collect a filtered cake. The filtered cake was baked dry, and then chemically reduced by hydrogen at 500° C. for 2 hours to obtain a catalyst C6 (loaded with ruthenium and Li₂NH). In the catalyst C6, ruthenium and the catalyst C6 had a weight ratio of 3:100, and the auxiliary agent Li₂NH and the catalyst C6 had a weight ratio of 11:100.

1.25 g of the catalyst C6 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 90%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 82%.

### Example 7

Magnesium nitrate (256 g) was dissolved in de-ionized water to form an aqueous solution (0.5 L). Sodium hydroxide (20 wt %) was dissolved in de-ionized water to form an aqueous solution (0.4 L). The aqueous solution of magnesium nitrate was added to the aqueous solution of sodium hydroxide, and then stirred at room temperature for 18 hours. Subsequently, 80 g of cerium oxide powder was added to the solution and continuously and evenly stirred, and then filtered to collect a filtered cake. The filtered cake was washed by water and then baked dry, and then sintered at 450° C. for 4 hours to obtain a support S7 (MgₓCe₍₁₋ₓ₎O₍₂₋ₓ₎, x=0.25).

The support S7 (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C7 (loaded with ruthenium). In the catalyst C7, ruthenium and the catalyst C7 had a weight ratio of 3:100.

1.25 g of the catalyst C7 was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 84%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 78%.

### Comparative Example 1

RuCl₃ (0.70 g) was added to THE solution of LiNH₂ (8 g) to be stirred and mixed, and THF was removed by vacuum to obtain a mixture of RuCl₃ and LiNH₂. The mixture was chemically reduced by hydrogen at 500° C. for 2 hours to obtain a catalyst C1′ (ruthenium and LiNH₂). In the catalyst C1′, ruthenium and the catalyst C1′ had a weight ratio of 3:100, and the auxiliary agent LiNH₂ and the catalyst C1′ had a weight ratio of 97:100.

1.25 g of the catalyst C1′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 52%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 45%. As shown in Comparative Example 1, using a catalyst lacking support caused a low conversion rate of the gaseous ammonia.

### Comparative Example 2

Magnesium oxide (MgO, 8 g) serving as a support was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C2′ (loaded with ruthenium). In the catalyst C2′, ruthenium and the catalyst C2′ had a weight ratio of 3:100.

1.25 g of the catalyst C2′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 72%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 60%. As shown in Comparative Example 2, the conversion rate of gaseous ammonia was low when the support was magnesium oxide.

### Comparative Example 3

The support S1 (8 g) in Example 1 was weighed and added to an aqueous solution of PdCl₂ (0.45 g) to perform incipient wetness impregnation. The impregnated support was filtered and baked dry, and then dried at 110° C. for 4 hours to obtain a support loaded with palladium precursor, which was then chemically reduced by hydrogen at 500° C. for 2 hours to obtain a catalyst C3′ (loaded with palladium). In the catalyst C3′, palladium and the catalyst C3′ had a weight ratio of 3:100.

1.25 g of the catalyst C3′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 25%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 18%. As shown in Comparative Example 3, the conversion rate of gaseous ammonia was low when ruthenium was replaced with another metal such as palladium.

### Comparative Example 4

Magnesium nitrate (25.34 g) and RuCl₃ (0.296 g) were dissolved in de-ionized water to form an aqueous solution (0.4 L). Potassium carbonate (0.3 M) was dissolved in de-ionized water to form an aqueous solution (0.4 L). The aqueous solution of magnesium nitrate and RuCl₃ was added to the aqueous solution of potassium carbonate, and then continuously stirred to form a precipitate, and then stood at room temperature for 18 hours. The precipitate was filtered to obtain a filtered cake. The filtered cake was washed by water and then baked dry, and then sintered at 450° C. for 4 hours to obtain MgO support loaded with ruthenium precursor and the auxiliary agent MgCO₃, which was then chemically reduced by hydrogen at 500° C. for 2 hours to obtain a catalyst C4′ (loaded with ruthenium and MgCO₃). In the catalyst C4′, the ruthenium and the catalyst C4′ had a weight ratio of 3:100.

1.25 g of the catalyst C4′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 80%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 75%. As shown in Comparative Example 4 and Examples 1 to 5, the catalyst of MgO support and the auxiliary agent MgCO₃ has a lower conversion rate of gaseous ammonia than that of the catalyst of AlMgO support and the optionally auxiliary agent LiNH₂.

### Comparative Example 5

Magnesium nitrate (50 g) and aluminum nitrate (357 g) were dissolved in de-ionized water to form an aqueous solution (1 L). Sodium hydroxide (20 wt %) was dissolved in de-ionized water to form an aqueous solution (0.7 L). The aqueous solution of magnesium nitrate and aluminum nitrate was added to the aqueous solution of sodium hydroxide, and then stirred at room temperature for 18 hours. Subsequently, 400 g of aluminum oxide powder was added to the solution and continuously and evenly stirred, and then filtered to collect a filtered cake. The filtered cake was washed by water and then baked dry, and then sintered at 450° C. for 4 hours to obtain a support S5′ (MgₓAl₍₁₋ₓ₎O_{(3-x)/2}, x=0.03).

The support S5′ (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C5′ (loaded with ruthenium). In the catalyst C5′, ruthenium and the catalyst C5′ had a weight ratio of 3:100.

1.25 g of the catalyst C5′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 73%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 63%. As shown in Comparative Example 5, the conversion rate of gaseous ammonia was low when the amount of Mg in the support MgₓAl₍₁₋ₓ₎O_{(3-x)/2} was too low.

### Comparative Example 6

Magnesium nitrate (300 g) and aluminum nitrate (80 g) were dissolved in de-ionized water to form an aqueous solution (1 L). Sodium hydroxide (20 wt %) was dissolved in de-ionized water to form an aqueous solution (0.6 L). The aqueous solution of magnesium nitrate and aluminum nitrate was added to the aqueous solution of sodium hydroxide, and then stirred at room temperature for 18 hours. Subsequently, 55 g of aluminum oxide powder was added to the solution and continuously and evenly stirred, and then filtered to collect a filtered cake. The filtered cake was washed by water and then baked dry, and then sintered at 450° C. for 4 hours to obtain the support S6′ (MgₓAl₍₁₋ₓ₎O_{(3-x)/2}, x=0.55).

The support S6′ (8 g) was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C6′ (loaded with ruthenium). In the catalyst C6′, ruthenium and the catalyst C6′ had a weight ratio of 3:100.

1.25 g of the catalyst C6′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 78%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 72%. As shown in Comparative Example 6, the conversion rate of gaseous ammonia was low when the amount of Mg in the support MgₓAl₍₁₋ₓ₎O_{(3-x)/2} was too high.

### Comparative Example 7

The support S1 (8 g) in Example 1 was weighed and added to an aqueous solution of RuCl₃ (0.83 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of LiNH₂ (2.3 g) to be stirred and mixed, and then filtered to collect a filtered cake. The filtered cake was baked dry, and then chemically reduced by hydrogen at 500° C. for 2 hours to obtain a catalyst C7′ (loaded with ruthenium and LiNH₂). In the catalyst C7′, ruthenium and the catalyst C7′ had a weight ratio of 3:100, and the auxiliary agent LiNH₂ and the catalyst C7′ had a weight ratio of 22:100.

1.25 g of the catalyst C7′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 81%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 72%. As shown in Comparative Example 7, the conversion rate of gaseous ammonia was low when the auxiliary agent amount was too high.

### Comparative Example 8

The support S5′ (8 g) in Comparative Example 5 was weighed and added to an aqueous solution of RuCl₃ (0.75 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of LiNH₂ (1.0 g) to be stirred and mixed, and then filtered to collect a filtered cake. The filtered cake was baked dry, and then chemically reduced by hydrogen at 500° C. for 2 hours to obtain a catalyst C8′ (loaded with ruthenium and LiNH₂). In the catalyst C8′, ruthenium and the catalyst C8′ had a weight ratio of 3:100, and the auxiliary agent LiNH₂ and the catalyst C8′ had a weight ratio of 11:100.

1.25 g of the catalyst C8′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 79%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 70%. As shown in Comparative Example 8, the conversion rate of gaseous ammonia was low when the amount of Mg in the support MgₓAl₍₁₋ₓ₎O_{(3-x)/2} was too low (even if an appropriate amount of auxiliary agent was loaded on the support).

### Comparative Example 9

Aluminum oxide (Al₂O₃, 8 g) serving as a support was weighed and added to an aqueous solution of RuCl₃ (0.7 g) to perform incipient wetness impregnation. The impregnated support was filtered and baked dry, and then dried at 110° C. for 4 hours to obtain a support loaded with ruthenium precursor, which was then chemically reduced by hydrogen at 500° C. for 2 hours to obtain a catalyst C9′ (loaded with ruthenium). In the catalyst C9′, ruthenium and the catalyst C9′ had a weight ratio of 3:100.

1.25 g of the catalyst C9′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 65%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 57%. As shown in Comparative Example 9, the conversion rate of gaseous ammonia was low when the support was aluminum oxide.

### Comparative Example 10

Aluminum oxide (8 g) serving as a support was weighed and added to an aqueous solution of RuCl₃ (0.75 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of LiNH₂ (1.0 g) to be stirred and mixed, and then filtered to collect a filtered cake. The filtered cake was baked dry, and then chemically reduced by hydrogen at 500° C. for 2 hours to obtain a catalyst C10′ (loaded with ruthenium and LiNH₂). In the catalyst C10′, ruthenium and the catalyst C10′ had a weight ratio of 3:100, and the auxiliary agent LiNH₂ and the catalyst C10′ had a weight ratio of 11:100.

1.25 g of the catalyst C10′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 72%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 62%. As shown in Comparative Example 10, the conversion rate of gaseous ammonia was low when the support was aluminum oxide (even if an appropriate amount of auxiliary agent was loaded on the support).

### Comparative Example 11

Aluminum oxide (8 g) serving as a support was weighed and added to an aqueous solution of RuCl₃ (0.75 g) to perform incipient wetness impregnation. The impregnated support was filtered and baked dry, and then dried at 110° C. for 4 hours to obtain a support loaded with ruthenium precursor.

KNO₃ (1.0 g) was dissolved in de-ionized water to form an aqueous solution. The support loaded with ruthenium precursor (8 g) was weighed and added to the aqueous solution of KNO₃ to be stirred and mixed, and then filtered to collect a filtered cake. The filtered cake was steamed dry and baked dry, and then chemically reduced by hydrogen at 500° C. for 2 hours to obtain a catalyst C11′ (loaded with ruthenium and potassium (K)). In the catalyst C11′, ruthenium and the catalyst C11′ had a weight ratio of 3:100, and the auxiliary agent K and the catalyst C11′ had a weight ratio of 5:100.

1.25 g of the catalyst C11′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 71%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 62%. As shown in Comparative Example 11, the conversion rate of gaseous ammonia was low when the aluminum oxide support was loaded with ruthenium and the auxiliary agent K.

### Comparative Example 12

Magnesium oxide (8 g) serving as a support was weighed and added to an aqueous solution of RuCl₃ (0.75 g) to perform incipient wetness impregnation. The impregnated support was filtered and baked dry, and then dried at 110° C. for 4 hours to obtain a support loaded with ruthenium precursor.

The support loaded with ruthenium precursor (8 g) was weighed and added to a THE solution of LiNH₂ (1.0 g) to be stirred and mixed, and then filtered to collect a filtered cake. The filtered cake was baked dry, and then chemically reduced by hydrogen at 500° C. for 2 hours to obtain a catalyst C12′ (loaded with ruthenium and LiNH₂). In the catalyst C12′, ruthenium and the catalyst C12′ had a weight ratio of 3:100, and the auxiliary agent LiNH₂ and the catalyst C12′ had a weight ratio of 11:100.

1.25 g of the catalyst C12′ was disposed in the quartz tube reactor, and gaseous ammonia of high purity was introduced into the quartz tube reactor to perform gaseous ammonia decomposition (e.g. gaseous ammonia was converted to hydrogen and nitrogen). When the gaseous ammonia decomposition was performed at a reaction temperature of 400° C. under a reaction pressure of 1 atm, and the gaseous ammonia had a gas hourly space velocity of 1,500 h⁻¹, the conversion rate of gaseous ammonia was 78%. When the gaseous ammonia decomposition was performed at a reaction temperature of 450° C. under a reaction pressure of 1 atm, and the gaseous ammonia had a gas hourly space velocity of 15,000 h⁻¹, the conversion rate of gaseous ammonia was 70%. As shown in Comparative Example 12, the conversion rate of gaseous ammonia was low when the support was magnesium oxide (even if an appropriate amount of auxiliary agent was loaded on the support).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A catalyst, comprising:
a ruthenium metal loaded on a support,
wherein the support has a chemical formula of AₓB₍₁₋ₓ₎O_{y},
wherein A is an alkaline earth metal, B is aluminum, zinc, cerium, manganese, or a combination thereof, x is 0.05 to 0.50, and y is chemical stoichiometry.

2. The catalyst as claimed in claim 1, further comprising an auxiliary agent loaded on the support, and the auxiliary agent is Li₃N, Li₂NH, or LiNH₂.

3. The catalyst as claimed in claim 2, wherein the auxiliary agent and the catalyst have a weight ratio of 0.1:100 to 20:100.

4. The catalyst as claimed in claim 1, wherein the alkaline earth metal is magnesium, calcium, or a combination thereof.

5. The catalyst as claimed in claim 1, wherein the ruthenium metal and the catalyst have a weight ratio of 0.5:100 to 7:100.

6. A method of decomposing gaseous ammonia, comprising:
contacting the catalyst as claimed in claim 1 with gaseous ammonia to form nitrogen and hydrogen,
wherein the catalyst contacts the gaseous ammonia at a temperature of 300° C. to 700° C. under a pressure of 1 atm to 1.2 atm.

7. The method as claimed in claim 6, wherein the gaseous ammonia has a gas hourly space velocity of 1,000 h⁻¹ to 60,000 h⁻¹.
